(19) United States
(12) Patent Application Publication
(10) Pub. No.: US 2002/0136292 A1
(43) Pub. Date: Sep. 26, 2002

(54) Encoding and decoding of video signals

(75) Inventor: Weiping Li, Palo Alto, CA (US)

Correspondence Address: Martin Novack, 17414 Via Capri East, Boca Raton, FL, 33496, US

(73) Assignee: WebCast Technologies, Inc.

(21) Appl. No.: 10/001,258

(22) Filed: Nov. 1, 2001

Related U.S. Application Data
(60) Provisional application No. 60/244,983, filed on Nov. 1, 2000.

(51) Int. Cl. H04N 7/12

(52) U.S. Cl. 375/240.01; 375/240.12

(57) ABSTRACT

The disclosure has application for use in conjunction with a video encoding/decoding technique wherein video images are encoded using truncatable image-representative signals in bit plane form. A disclosed method includes the following steps: determining a specified number of bitplanes for the coding of an image-representative frame; and producing an encoded bitstream for the frame which has a syntax-containing portion that includes a representation of the specified number.

### RELATED APPLICATION

This application claims priority from U.S. Provisional Patent Application No. 60/244983, filed Nov. 1, 2000, and said Provisional Patent Application is incorporated herein by reference.

### FIELD OF THE INVENTION

This invention relates to encoding and decoding of video signals, and, more particularly, to a method and apparatus that enables conformance testing of scalable decoders.

### BACKGROUND OF THE INVENTION

Conformance testing is a very important element of a standard, such as MPEG-4. Conformance testing of a video decoder is a process of testing a decoder with a set of so-called conformance bitstreams. FIG. 1 shows a typical configuration for conformance testing of a video decoder.

In the conformance testing, a conformance bitstream 110 is an input to the decoder under test, 130, as well as to the standard reference decoder 120. The result generated by the decoder under test is compared, 150, with that generated by the reference decoder. If the difference is within the defined limit, the decoder under test passes the test for the given conformance bitstream. If the decoder under test passes the test for a set of conformance bitstreams defined for a given profile at a given level, the decoder under test can be claimed as a conformant decoder for that profile at that level.

This conformance procedure has been a common practice for any standard based decoders to ensure interoperability. For non-scalable or layered scalable video coding techniques, the conformance bitstreams can be generated by setting up the parameters to the maximum values defined in the profile at the level. One of the parameters is the maximum bitrate. For layered scalable coding, there is the maximum enhancement layer bitrate as well as the maximum base layer bitrate. However, for fine granularity scalable (FGS) coding techniques, such as the one defined in MPEG-4 Final Proposed Draft Amendment (FPDAM), there is a problem to use the maximum bitrate for the enhancement layer conformance.

In a video coding technique with fine granularity scalability (FGS), such as the one in MPEG-4, a bitstream of each frame can be truncated into any number of bits and can still be decodable to reconstruct the frame. The video quality of the frame is proportional to the number of bits received and decoded by the decoder. In an application, the video encoder takes the original sequence as the input and encodes it into the base layer and enhancement layer bitstreams. The base layer bitstream is at a fixed bitrate and the enhancement layer bitstream can be truncated into any given bitrate. However, from the conformance definition, any truncated bitstreams cannot be conformance bitstreams because they contain incomplete syntax elements at the end of each frame due to the truncation. If the maximum bitrate is used as a conformance point for the enhancement layer, it is impossible in practice to generate the conformance bitstreams at maximum bitrate. It is among the objects of the present invention to solve this problem.

### SUMMARY OF THE INVENTION

A feature of the present invention provides a coding parameter that relates to the bitrate of the enhancement layer in the sense that a higher or lower enhancement bitrate corresponds to a larger or smaller value of this parameter, respectively. At the same time, this parameter is easier to control than the bitrate in terms of generating conformance bitstreams.

The present invention has application, inter alia, for use in conjunction with a video encoding/decoding technique wherein video images are encoded using truncatable image-representative signals in bit plane form. An embodiment of the method of the invention includes the following steps: determining a specified number of bit planes for the coding of an image-representative frame; and producing an encoded bitstream for the frame which has a syntax-containing portion that includes a representation of said specified number.

In a form of the invention, the method includes providing a decoder for decoding the encoded bitstream and further comprises the step of performing conformance testing on the decoder at a conformance level that is a function of said specified number. In a preferred embodiment of this form of the invention, the encoding/decoding technique comprises a fine granularity scaling encoding/decoding technique.

Further features and advantages of the invention will become more readily apparent from the following detailed description when taken in conjunction with the accompanying drawings.

### BRIEF DESCRIPTION OF THE DRAWINGS

FIG. 1 is a simplified diagram illustrating a standard process for conformance testing.

FIG. 2 is a block diagram of an apparatus which can be used in practicing embodiments of the invention.

FIG. 3 is a diagram illustrating a maximum number of bitplanes in a frame for three color components (Y,U,V) for an example hereof.

FIG. 4 is a table illustrating syntax parameters for an example of an embodiment of the invention.

FIG. 5 is a table illustrating parameters for profile/level definition, including the parameter for number of coded bit planes.

FIG. 6 is a flow diagram of a routine for programming the encoder processor in accordance with an embodiment of the invention.

FIG. 7 is a flow diagram of a routine for programming the decoder processor in accordance with an embodiment of the invention.

### DETAILED DESCRIPTION

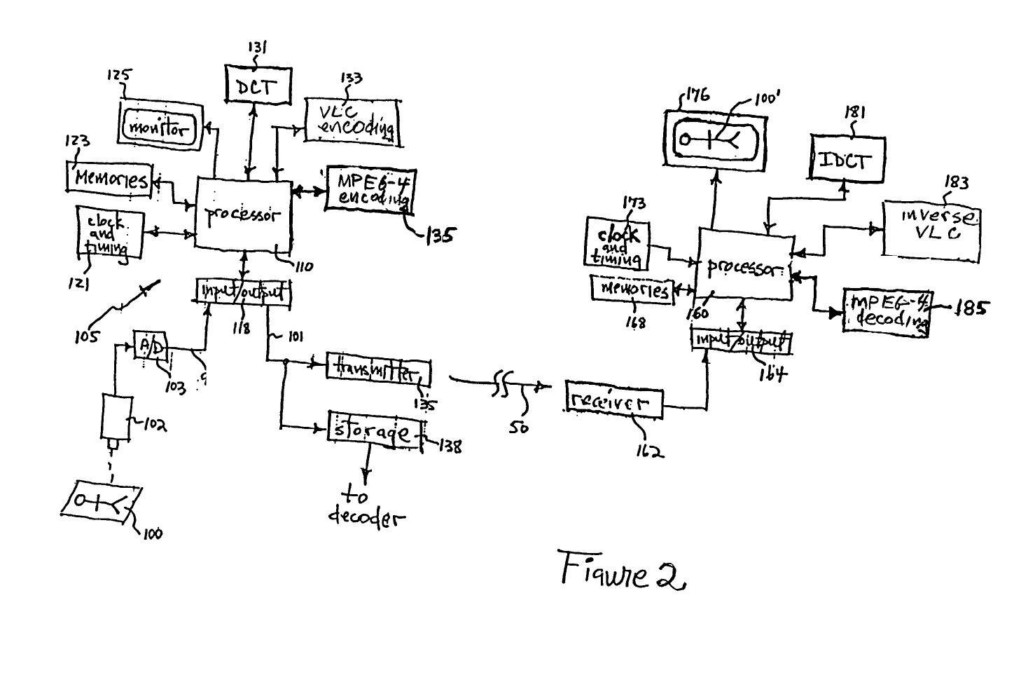

Referring to FIG. 2 there is shown a block diagram of an apparatus, at least parts of which can be used in practicing embodiments of the invention. A video camera 102, or other source of video signal, produces an array of pixel-representative signals that are coupled to an analog-to-digital converter 103, which is, in turn, coupled to the processor 110 of an encoder 105. When programmed in the manner to be described, the processor 110 and its associated circuits can be used to implement embodiments of the invention. The processor 110 may be any suitable processor, for example an electronic digital processor or microprocessor. It will be understood that any general purpose or special purpose processor, or other machine or circuitry that can perform the functions described herein, electronically, optically, or by other means, can be utilized. The processor 110, which for purposes of the particular described embodiments hereof can be considered as the processor or CPU of a general purpose electronic digital computer, will typically include memories 123, clock and timing circuitry 121, input/output functions 118 and monitor 125, which may all be of conventional types. In the present embodiment blocks 131, 133, and 135 represent functions that can be implemented in hardware, software, or a combination thereof. The block 131 represents a discrete cosine transform function that can be implemented, for example, using commercially available DCT chips or combinations of such chips with known software, the block 133 represents a variable length coding (VLC) encoding function, and the block 135 represents other known MPEG-4 encoding modules, it being understood that onlyl those known functions needed in describing and implementing the invention are treated in describing and implementing the invention are treated herein in any detail.

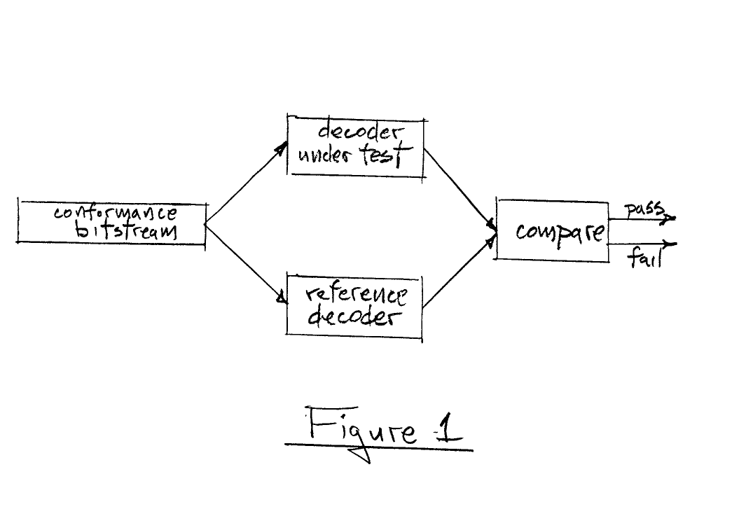

With the processor appropriately programmed, as described hereinbelow, an encoded output signal 101 is produced which can be a compressed version of the input signal 90 and requires less bandwidth and/or less memory for storage. In the illustration of FIG. 1, the encoded signal 101 is shown as being coupled to a transmitter 135 for transmission over a communications medium (e.g. air, cable, network, fiber optical link, microwave link, etc.) 50 to a receiver 162. The encoded signal is also illustrated as being coupled to a storage medium 138, which may alternatively be associated with or part of the processor subsystem 110, and which has an output that can be decoded using the decoder to be described.

Coupled with the receiver 162 is a decoder 155 that includes a similar processor 160 (which will preferably be a microprocessor in decoder equipment) and associated peripherals and circuits of similar type to those described in the encoder. These include input/output circuitry 164, memories 168, clock and timing circuitry 173, and a monitor 176 that can display decoded video 100′. Also provided are blocks 181, 183, and 185 that represent functions which (like their counterparts 131, 133, and 135 in the encoder) can be implemented in hardware, software, or a combination thereof. The block 181 represents an inverse discrete cosine transform function, the block 183 represents an inverse variable length coding function, and the block 185 represents other MPEG-4 decoding functions.

A feature of the present invention provides a coding parameter that relates to the bitrate of the enhancement layer in the sense that a higher or lower enhancement bitrate corresponds to a larger or smaller value of this parameter, respectively. At the same time, this parameter is easier to control than the bitrate in terms of generating conformance bitstreams. Using MPEG-4 FGS video coding as an example,an embodiment of the technique is described.

The FGS enhancement encoder of MPEG-4 takes the original frame and reconstructed frame as input and produces an FGS enhancement bitstream. The difference between the original and reconstructed frames is transformed by DCT to generate a DCT residue. After obtaining all the DCT residues of a frame, the maximum absolute value of the residues is found and the maximum number of bitplanes for the frame is determined. The 64 absolute values of each residue block are zigzag ordered into an array. A bitplane is defined as an array of 64 bits, taken one from each absolute value of the residues at the same bit significance position. For each bitplane of each block, (RUN, EOP) symbols are formed and variable length encoded to produce the output bitstream. Starting from the most significant bitplane (MSB plane), 2-D symbols are formed of two components: (a) number of consecutive 0's before a 1 (RUN), (b) whether there are any 1's left on this bitplane, i.e. End-Of-Plane (EOP). If a bitplane after the MSB plane contains all 0's, a special symbol ALL-ZERO is formed to represent it.

The following example illustrates the procedure. Assume that the absolute residue values and the sign bits after zigzag ordering are given as follows:

10, 0, 6, 0, 0, 3, 0, 2, 2, 0, 0, 2, 0, 0, 1, 0, . . . , 0, 0 (absolute values)

0, x, 1, x, x, 1, x, 0, 0, x, x, 1, x, x, 0, x, . . . , x, x (sign bits)

The maximum value in this block is found to be 10 and the number of bits to represent 10 in the binary format (1010) is 4. Therefore, the 4 bitplanes are considered in forming the (RUN, EOP) symbols. Writing every value in the binary format, the 4 bitplanes are formed:

1, 0, 0, 0, 0, 0, 0, 0, 0, 0, 0, 0, 0, 0, 0, 0, . . . 0, 0 (MSB)

0, 0, 1, 0, 0, 0, 0, 0, 0, 0, 0, 0, 0, 0, 0, 0, . . . 0, 0 (MSB-1)

1, 0, 1, 0, 0, 1, 0, 1, 1, 0, 0, 1, 0, 0, 0, 0, . . . 0, 0 (MSB-2)

0, 0, 0, 0, 0, 1, 0, 0, 0, 0, 0, 0, 0, 0, 1, 0, . . . 0, 0 (MSB-3)

Converting the four bit-planes into (RUN, EOP) symbols:

| | |
|---|---|
| (0, 1) | (MSB) |
| (2, 1) | (MSB-1) |
| (0, 0), (1, 0), (2, 0), (1, 0), | (MSB-2) |
| (0, 0), (2, 1) | |
| (5, 0), (8, 1) | (MSB-3) |

Therefore, 10 (RUN, EOP) symbols are formed in this example. These symbols are coded using variable length code together with the sign bits as follows. Each sign bit is put into the bitstream only once right after the VLC code that contains the MSB of the non-zero absolute value associated with the sign bit.

| | |
|---|---|
| VLC(0, 1), 0 | (MSB) |
| VLC(2, 1), 1 | (MSB1) |
| VLC(0, 0), VLC(1, 0), VLC(2, 0), 1, VLC(1, 0), 0, VLC(0, 0), | (MSB2) |
| 0, VLC(2, 1), 1 | |
| VLC(5, 0), VLC(8, 1), 0 | (MSB3) |

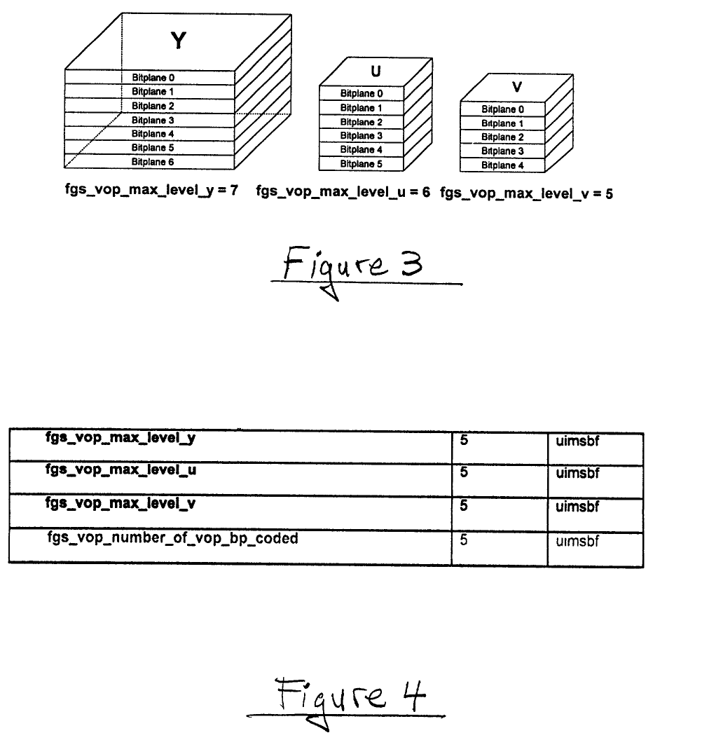

The maximum number of bitplanes in a frame is found and coded in the header of each frame. As shown in FIG. 3, the three color components (Y, U, V) may have different number of bitplanes.

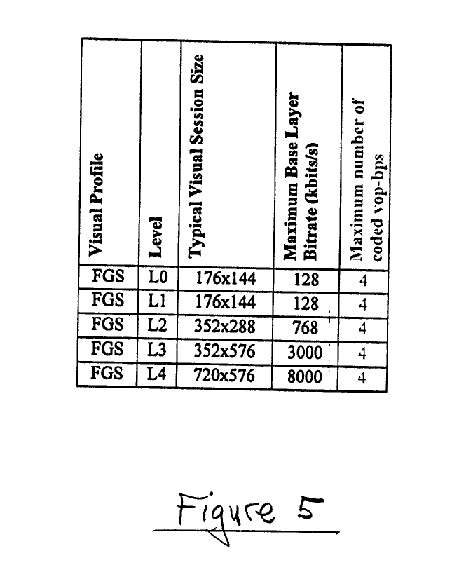

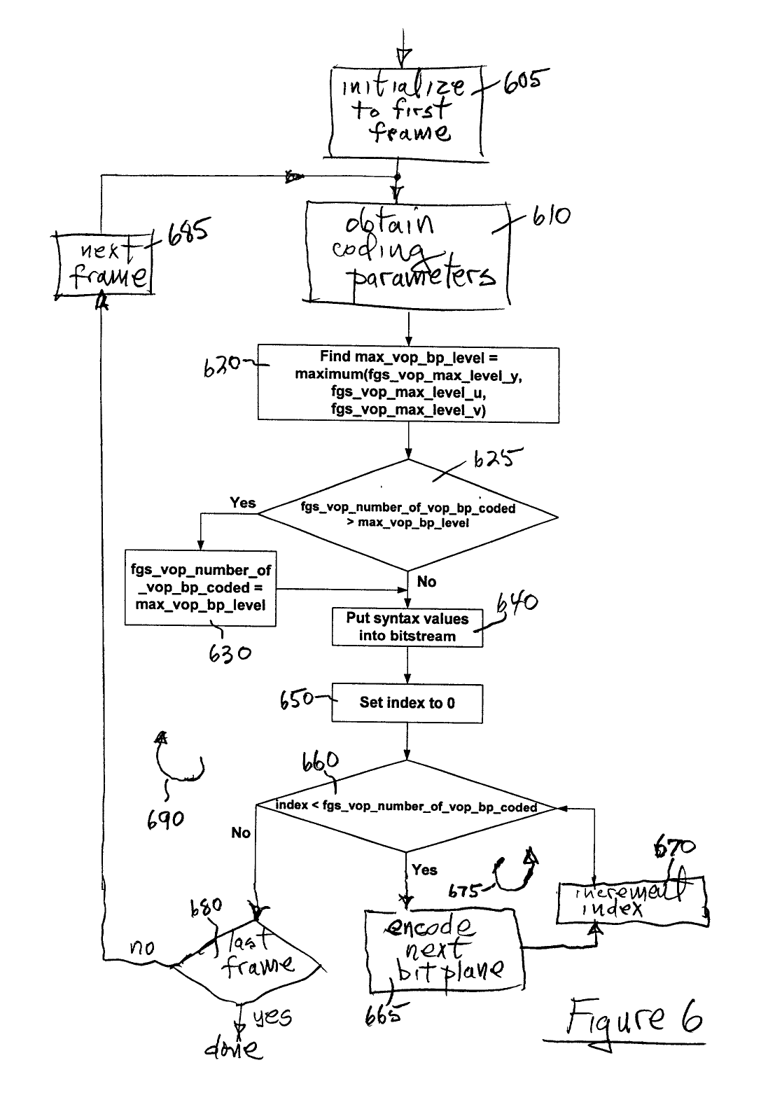

Therefore, in this there are three syntax values fgs_vop_max_level_y, fgs_vop_max_level_u, and fgs_vop_max_level_v in the frame header to indicate the maximum numbers of bitplanes for the Y, U, V components in the frame respectively. (MPEG-4 abbreviations are employed, where available.) Usually, all the bitplanes are coded and truncation of the bitstream is used to get any given bitrate. In the embodiment hereof to enable conformance, there is introduced a parameter called “fgs_vop_number_vop_bp_coded” which is illustrated in the syntax table of FIG. 4. The three syntax elements fgs_vop_max_level_y, fgs_vop_max_level_u, and fgs_vop_max_level_v indicate the maximum numbers of bitplanes for Y, U, V color components. The new syntax element fgs_vop_number_vop_bp_coded is introduced to indicate how many bitplanes out of the maximum are coded into the bitstream. The more bitsplanes coded into the bitstream, the higher the bitrate is. Therefore, the bitrate in the enhancement layer is proportionally related to the number of bitplanes coded. Unlike the bitrate, the number of bitplanes coded is very easy to control in the encoder. Therefore, this parameter can be used for conformance purposes. In the profile/level definitions, this parameter is used to limit the worst case complexity. The conformance bitstreams can be easily generated by coding the number of bitplanes into the bitstreams according to the profile/level definitions. An example of using this parameter for profile/level definition is shown in the table of FIG. 5.

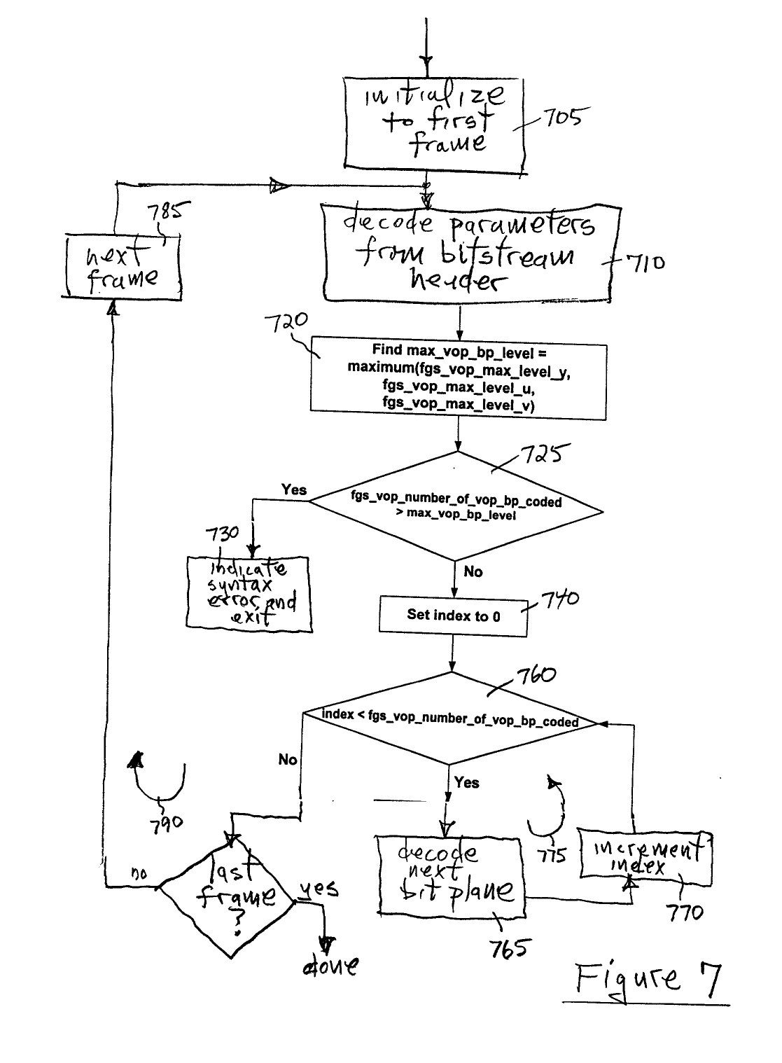

Referring to FIG. 6, there is shown a flow diagram of a routine for programming the encoder processor in accordance with an embodiment of the invention. The block 605 represents initializing to the first frame to be processed. The coding parameters are input (block 610), and then utilized (block 620) to find the maximum (called max_vop_bp_level) of the three syntax values fgs_vop-max-level-y, fgs_vop-max_level-u, and fgs_vop_max_level_v (see e.g. the example of FIG. 3 wherein these are 7, 6, and 5, respectively, so the maximum for this example is 7); that is, max_vop_bp_level=7. Determination is then made as to whether the specified number of bit planes coded (fgs_vop_number_of_vop_bp_coded) is greater than the max_vop_bp_level. If so, a condition is violated, and the number of bit planes coded is reduced (block 630) to the previously determined maxiumum. If not (e.g. in the present example, where the specified maximum number of bit planes to be coded is 4), the block 640 is entered, this block representing inserting of the syntax values into the header of the bitstream. Next, an index is initialized at zero (block 650) and determination is made (decision block 660) as to whether the index has reached the maximum number of bit planes to be coded. If not, a bit plane is encoded (block 665), the index is incremented (block 670), and the loop 675 continues until all bit planes (four of them in this example) have been encoded. Determination is then made (decision block 680) as to whether the last frame to be encoded has been processed. If not, the next frame is treated (block 685), and the loop 690 continues until all frames have been processed.

Referring to FIG. 7, there is shown a flow diagram of a routine for programming the decoder processor in accordance with an embodiment of the invention. The block 705 represents initializing to the first frame to be processed. The coded parameters are then decoded from the header of the bitstream (block 710) and then utilized to determine the maximum (called max_vop_bp_level) of the three syntax values fgs_vop-max-level-y, fgs_vop-max_level-u, and fgs_vop_max_level_v . Determination is then made (decision block 725) as to whether the specified number of bit planes coded (fgs_vop_number_of_vop_bp_coded) is greater than the max_vop_bp_level. If so, a syntax error is evident, and a suitable message is indicated (block 730). If not, an index is initialized at zero (block 740) and determination is made (decision block 760) as to whether the index has reached the maximum number of bit planes coded. If not, a bit plane is decoded (block 765), the index is incremented (block 770), and the loop 775 continues until all bit planes (four of them in this example) have been decoded. Determination is then made (decision block 780) as to whether the last frame to be decoded has been processed. If not, the next frame is treated (block 785), and the loop 790 continues until all frames have been processed.

1. For use in conjunction with a video encoding/decoding technique wherein images are encoded using truncatable image-representable signals in bit plane form, the method comprising the steps of:
determining a specified number of bitplanes for the coding of an image-representative frame; and
producing an encoded bitstream for said frame which has a syntax-containing portion that includes a representation of said specified number.

2. The method as defined by claim 1, further comprising the step of providing a decoder for decoding said encoded bitstream.

3. The method as defined by claim 2, further comprising the step of performing conformance testing on said decoder at a conformance level that is a function of said specified number.

4. The method as defined by claim 1, wherein said encoding/decoding technique comprises a fine granularity scaling encoding/decoding technique.

5. The method as defined by claim 3, wherein said encoding/decoding technique comprises a fine granularity scaling encoding/decoding technique.

6. The method as defined by claim 4, wherein said fine granularity scaling encoding/decoding technique is MPEG-4 fine granularity scaling.

7. The method as defined by claim 5, wherein said fine granularity scaling encoding/decoding technique is MPEG-4 fine granularity scaling.

8. The method as defined by claim 1, further comprising repeating said determining and producing steps for a number of frames of a video signal.

9. The method as defined by claim 3, further comprising repeating said determining and producing steps for a number of frames of a video signal.

10. The method as defined by claim 7, further comprising repeating said determining and producing steps for a number of frames of a video signal.

11. For use in conjunction with a video encoding/decoding technique wherein images are encoded using truncatable image-representable signals in bit plane form, and subsequently decoded with a decoder, a method for conformance testing of said decoder, comprising the steps of:
determining a specified number of bitplanes for the coding of an image-representative frame;
producing an encoded bitstream for said frame which has a syntax-containing portion that includes a representation of said specified number; and
performing conformance testing on said decoder at a conformance level that is a function of said specified number.

12. The method as defined by claim 11, wherein said encoding/decoding technique comprises a fine granularity scaling encoding/decoding technique.

13. The method as defined by claim 12, wherein said fine granularity scaling encoding/decoding technique is MPEG-4 fine granularity scaling.

14. The method as defined by claim 11, further comprising repeating said determining and producing steps for a number of frames of a video signal.

15. The method as defined by claim 13, further comprising repeating said determining and producing steps for a number of frames of a video signal.

16. For use in conjunction with an image encoding/decoding technique wherein images are encoded using truncatable image-representable signals in bit plane form, an apparatus comprising:
means for determining a specified number of bitplanes for the coding of an image-representative frame; and
means for producing an encoded bitstream for said frame which has a syntax-containing portion that includes a representation of said specified number.

17. Apparatus as defined by claim 16, further comprising a decoder for decoding said encoded bitstream.
